(19) United States
(12) Patent Application Publication
(10) Pub. No.: US 2023/0203233 A1
(43) Pub. Date: Jun. 29, 2023

(54) AQUEOUS POLYURETHANE DISPERSION AND TEXTILE

(71) Applicant: Industrial Technology Research Institute, Hsinchu (TW)

(72) Inventors: Albert Wan, Hsinchu City (TW); Yu-Ting Chen, Taoyuan City (TW); Min-Yan Dong, Changhua County (TW); Jing-Wen Tang, Hsinchu City (TW)

(73) Assignee: Industrial Technology Research Institute, Hsinchu (TW)

(21) Appl. No.: 17/564,227

(22) Filed: Dec. 29, 2021

(51) Int. Cl. C08G 18/40; C08G 18/73; C09D 175/06

(52) U.S. Cl. CPC C08G 18/4018; C08G 18/73; C09D 175/06

(57) ABSTRACT

An aqueous polyurethane dispersion and a textile are provided. The aqueous polyurethane dispersion includes water and a bio-based polyurethane. The bio-based polyurethane includes bio-based polyester polyol, hydrophilic polyol, isocyanate, and hydrophilic compound. A weight ratio of the bio-based polyester polyol to the hydrophilic polyol is 2.7:1 to 5.3:1.

### TECHNICAL FIELD

The disclosure relates to a polyurethane dispersion, and particularly to an aqueous polyurethane dispersion and a textile.

### BACKGROUND

In recent years, with the rapid growth of textile industry, environmental issues such as climate changes have received considerable attention. For example, products made from renewable sources can bring resource sustainability and carbon reduction benefits. Therefore, water-saving and/or energy-saving sustainable processes have become top priority in textile industry. According to statistics, textiles with moisture wicking performance account for a very high percentage of all textile market. However, the existing compositions and methods for fabricating moisture absorbing and moisture wicking textiles are not efficient in energy usage and/or water consumption, which further affecting the environment.

### SUMMARY

An aqueous polyurethane dispersion of the present disclosure, includes water and a bio-based polyurethane. The bio-based polyurethane includes bio-based polyester polyol, hydrophilic polyol, isocyanate, and hydrophilic compound. A weight ratio of the bio-based polyester polyol to the hydrophilic polyol is 2.7:1 to 5.3:1.

A textile of the present disclosure is prepared using the aforementioned aqueous polyurethane dispersion.

To make the aforementioned features of the invention more obvious and comprehensible, embodiments accompanied with drawings are particularly described in detail below.

### BRIEF DESCRIPTION OF THE DRAWINGS

None.

### DESCRIPTION OF THE EMBODIMENTS

Below, exemplary embodiments will be described in detail. The inventive concept may be embodied in various forms without being limited to the exemplary embodiments set forth herein. Description of well-known parts are omitted for clarity, and like reference numerals refer to like elements throughout.

The present disclosure provides an aqueous polyurethane dispersion, including water and a bio-based polyurethane. The bio-based polyurethane includes bio-polyester polyol, hydrophilic polyol, isocyanate, and hydrophilic compounds. In addition, the aqueous polyurethane dispersion of the present disclosure may further include chain extender, solvent, and additives if necessary. Hereinafter, the aforementioned compositions will be described in detail.

The bio-based polyester polyol is not particularly limited, and a suitable bio-based polyester polyol can be selected depending on demands. For example, the bio-based polyester polyol can include poly(1,2-propylene succinate) (PPS), polypropanediol (PPD), polycaprolactone diols (HOPCLOH) or other suitable bio-based polyester polyols. The bio-based polyester polyol can be used alone or in combination thereof. In the present embodiment, the bio-based polyester polyol is preferably poly(1,2-propylene succinate). When the aqueous polyurethane dispersion includes a bio-based polyester polyol, the textile which is prepared with the aqueous polyurethane dispersion can have good moisture absorption and moisture wicking properties.

The hydrophilic polyol is not particularly limited, and a suitable hydrophilic polyol can be selected depending on demands. For example, the hydrophilic polyol may include poly(ethylene glycol) (PEG), poly(propylene glycol) (PPG). PEG-PPG copolymer, or other suitable hydrophilic polyols. The hydrophilic polyol can be used alone or in combination thereof. In the present embodiment, the hydrophilic polyol is preferably polyethylene glycol. When the aqueous polyurethane dispersion includes a hydrophilic polyol, the textile which is prepared with the aqueous polyurethane dispersion can have good moisture absorption property.

A weight ratio of the bio-based polyester polyol to the hydrophilic polyol is 2.7:1 to 5.3:1, preferably 4.0:1 to 4.4:1. When the weight ratio of the hydrophilic polyol to the bio-based polyester polyol is within the aforementioned range, the textile which is prepared with the aqueous polyurethane dispersion can have good moisture absorption and moisture wicking properties.

The kind of isocyanate is not particularly limited, and a suitable isocyanate can be selected depending on demands. The isocyanate may include a bio-based isocyanate, a non-bio-based isocyanate, or in combination thereof. A weight ratio of the isocyanate to the hydrophilic polyol is 0.99:1 to 2.18:1.

For example, the bio-based isocyanate may include bio-based hexamethylene diisocyanate (HDI), pentamethylene diisocyanate (PDI), L-lysine diisocyanate (LDI) or other suitable bio-based isocyanates. The bio-based isocyanate can be used alone or in combination thereof. In this embodiment, the bio-based isocyanate is preferably bio-based hexamethylene diisocyanate.

For example, the non bio-based isocyanate may include isophorone diisocyanate (IPDI), toluene diisocyanate (TDI), dicyclohexylmethane diisocyanate (dicyclohexylmethane diisocyanate, DMDI), or other suitable non bio-based isocyanates. The non bio-based isocyanates can be used alone or in combination thereof. In this embodiment, the non bio-based isocyanate is preferably isophorone diisocyanate.

The hydrophilic compound is not particularly limited, and a suitable hydrophilic compound can be selected depending on demands. In this embodiment, the hydrophilic compound may include at least two hydroxyl groups and at least one carboxyl group, and preferably includes two hydroxyl groups and one carboxyl group. Hydrophilic compound may include glyceric acid, 2,2-dimethylol propionic acid (DMPA), 2,2-bis (hydroxymethyl) butyric acid (DMBA) or other suitable hydrophilic compounds. The hydrophilic compound can be used alone or in combination thereof. In this embodiment, the hydrophilic compound is preferably glyceric acid, 2,2-dimethylolpropionic acid or in combination thereof. A weight ratio of the hydrophilic compound to the hydrophilic polyol is 0.37:1 to 0.53:1.

The chain extender is not particularly limited, and a suitable chain extender can be selected depending on demands. In this embodiment, the chain extender may include an amino group (amino), which includes ethylenediamine (EDA), triethylenetetramine (TETA), diethylenetriamine (DETA) or suitable chain extenders. The chain extender can be used alone or in combination thereof. In this embodiment, the chain extender is preferably ethylenediamine, ethylenetetramine or a combination thereof. A weight ratio of chain extender to hydrophilic polyol is 0.02:1 to 0.04:1.

The solvent is not particularly limited, and a suitable solvent can be selected depending on demands. For example, the solvent may include acetone, butanone or other suitable solvents. The solvent can be used alone or in combination thereof. In this embodiment, the solvent is preferably acetone.

The additives are not particularly limited, and suitable additive can be selected depending on demands. For example, the additives may include neutralizer, moisturizer, antibacterial agent, or other suitable additives. The additives may be used alone or in combination thereof. In this embodiment, the additive is preferably a neutralizer. The neutralizer may include triethylamine (TEA), dimethyl isopropylamine (DMIPA) or other suitable neutralizers. In this embodiment, the neutralizing agent is preferably dimethyl isopropylamine.

The preparation method of the aqueous polyurethane dispersion is not particularly limited. For example, bio-based polyester polyol, hydrophilic polyol, isocyanate, hydrophilic compound and solvent are added into a mixer, and stirred to obtain a uniformly mixed solution. After the polymerization reaction is completed, water is added for emulsification, the chain extender and additives can be added if necessary, and then after mixing uniformly, an aqueous polyurethane dispersion solution can be obtained. Next, after solvent removal from the aqueous polyurethane dispersion solution, an aqueous polyurethane dispersion can be obtained.

An exemplary embodiment of the present invention provides a textile prepared using the aforementioned aqueous polyurethane dispersion.

A textile with good moisture absorption and moisture wicking properties can be formed by coating the aforementioned aqueous polyurethane dispersion on the textile to form a coating film, and dry (setting) the coating film. For example, after coating the aqueous polyurethane dispersion on the textile, the coated film is dried at a temperature of 140-180° C. for 90-120 seconds, to form a coating film on the textile, thereby improving the moisture absorption and moisture wicking properties of the textile.

The textile can be a synthetic fiber, a natural fiber, a semi-synthetic fiber or other suitable materials can be used with no particular limitation.

The coating method is not particularly limited, however impregnation method, the spray-coating method or other suitable methods such as digital printing can be applied, and in general, the impregnation method is widely used.

In this embodiment, according to the AATCC 79 test method, the wicking height of the textile is greater than 10 cm/15 minutes; and the water absorption time is less than 3 seconds.

Hereinafter, the present invention will be described in detail with reference to examples. The following examples are provided to describe the present invention, and the scope of the present invention includes the categories described in the scope of the following patent applications and their substitutions and modifications, and is not limited to the scope of the examples.

The following describes the preparation example of the aqueous polyurethane dispersion, and the experimental examples and the comparative experimental examples of the textiles. Hereinafter, the parts by weight of each composition is based on 100 parts by weight of the total weight of the bio-based polyester polyol, hydrophilic polyol, isocyanate, hydrophilic compound and chain extender.

### Preparation Example 1

About 58.24 parts by weight of bio-based poly(1,2-propylene succinate) (PPS) with average molecular weight of about 1000; biomass content of 100%, about 11.19 parts by weight of polyethylene glycol (PEG); with average molecular weight of about 2500 and a suitable amount of tetrabutyl titanate were added to a proper amount of acetone, the compositions were stirred at 200 rpm and heated at 40° C. to completely dissolve in acetone. Then, about 24.3 parts by weight of isophorone diisocyanate (IPDI) was added dropwise, and stirred at 200 rpm, and at a temperature of 50˜60° C. for 30 minutes. Subsequently, about 5.82 parts by weight of 2,2-dimethylol propionic acid (DMPA) was added to obtain a mixed solution. After that, deionized water which volume being 3 times the volume of the aforementioned mixed solution, was added in within 10 minutes at a rotation speed of 500 rpm and a temperature 50˜60° C. Then, at a rotation speed of 500 rpm and a temperature 50˜60° C., within 5 minutes about 0.45 parts by weight of ethylene diamine (EDA) was added dropwise. Then keep stirring under the same conditions for 1 hour. Next, after removing the acetone with distillation method at a temperature of 50° C., the remaining solution was diluted with water to obtain an aqueous polyurethane dispersion with a solid content of approximately 4.5% by weight (biomass content of approximately 26%).

### Preparation Example 2

About 64.79 parts by weight of bio-based poly(1,2-propylene succinate), about 14.72 parts by weight of polyethylene glycol and a suitable amount of tetrabutyl titanate were added to a proper amount of acetone, the compositions were stirred at 200 rpm and heated at 40° C. to completely dissolve in acetone. Then, about 14.59 parts by weight of 1,6-hexamethylene diisocyanate (HDI; biomass content of 32%) was added dropwise, and stirred at a rotation speed of 200 rpm, and at a temperature of 50˜60° C. for 30 minutes. Subsequently, about 5.56 parts by weight of 2,2-dimethylol propionic acid was added to obtain a mixed solution. After that, deionized water which volume being 3 times the volume of the aforementioned mixed solution, within 10 minutes added in at a rotation speed of 500 rpm and a temperature 50˜60° C. Then, at a rotation speed of 500 rpm and a temperature 50˜60° C., within 5 minutes about 0.34 parts by weight of ethylene diamine (EDA) was added dropwise. Then keep stirring under the same conditions for 1 hour. Next, after removing the acetone with distillation method at a temperature of 50° C. the remaining solution was diluted with water to obtain an aqueous polyurethane dispersion with a solid content of approximately 4.5% by weight (biomass content of approximately 45%).

### Preparation Example 3

About 62.62 parts by weight of bio-based poly(1,2-propylene succinate), about 15.62 parts by weight of polyethylene glycol and a suitable amount of tetrabutyl titanate were added to a proper amount of acetone, the compositions were stirred at 200 rpm and heated at 40° C. to completely dissolve in acetone. Then, about 15.49 parts by weight of 1,6-hexamethylene diisocyanate was added dropwise, and stirred at a rotation speed of 200 rpm, and at a temperature of 50˜60° C. for 30 minutes. Subsequently, about 5.91 parts by weight of 2,2-dimethylol propionic acid was added to obtain a mixed solution. After that, deionized water which volume being 3 times the volume of the aforementioned mixed solution, was added in within 10 minutes at a rotation speed of 500 rpm and a temperature 50˜60° C. Then, at a rotation speed of 500 rpm and a temperature 50˜60° C. Then, at a rotation speed of 500 rpm and a temperature 50˜60° C., within 5 minutes about 0.45 parts by weight of ethylene diamine was added dropwise. Then keep stirring under the same conditions for 1 hour. Next, after removing the acetone with distillation method at a temperature of 50° C., the remaining solution was diluted with water to obtain an aqueous polyurethane dispersion with a solid content of approximately 4.5% by weight (biomass content of approximately 44%).

### Preparation Example 4

About 53.71 parts by weight of bio-based poly(1,2-propylene succinate), about 19.35 parts by weight of polyethylene glycol and a suitable amount of tetrabutyl titanate were added to a proper amount of acetone, the compositions were stirred at 200 rpm and heated at 40° C. to completely dissolve in acetone. Then, about 19.19 parts by weight of 1,6-hexamethylene diisocyanate was added dropwise, and stirred at a rotation speed of 200 rpm, and at a temperature of 50˜60° C. for 30 minutes. Subsequently, about 7.31 parts by weight of 2,2-dimethylol propionic acid was added to obtain a mixed solution. After that, deionized water which volume being 3 times the volume of the aforementioned mixed solution, was added in within 10 minutes at a rotation speed of 500 rpm and a temperature 50˜60° C. Then, at a rotation speed of 500 rpm and a temperature 50˜60° C. within 5 minutes about 0.44 parts by weight of ethylene diamine was added dropwise. Then keep stirring under the same conditions for 1 hour. Next, after removing the acetone with distillation method at a temperature of 50° C. the remaining solution was diluted with water to obtain an aqueous polyurethane dispersion with a solid content of approximately 4.5% by weight (biomass content of approximately 39%).

### Comparative Preparation Example 1

58.74 parts by weight of bio-based poly(1,2-propylene succinate), about 10.44 parts by weight of polyethylene glycol and a suitable amount of tetrabutyl titanate were added to a proper amount of acetone, the compositions were stirred at 200 rpm and heated at 40° C. to completely dissolve in acetone. Then, about 24.5 parts by weight of isophorone diisocyanate was added dropwise, and stirred at a rotation speed of 200 rpm, and at a temperature of 50˜60° C. for 30 minutes. Subsequently, about 5.87 parts by weight of 2,2-dimethylol propionic acid was added to obtain a mixed solution. After that, deionized water which volume being 3 times the volume of the aforementioned mixed solution, was added in within 10 minutes at a rotation speed of 500 rpm and a temperature 50˜60° C. Then, at a rotation speed of 500 rpm and a temperature 50˜60° C. within 5 minutes about 0.45 parts by weight of ethylene diamine was added dropwise. Then keep stirring under the same conditions for 1 hour. Next, after removing the acetone with distillation method at a temperature of 50° C., the remaining solution was diluted with water to obtain an aqueous polyurethane dispersion with a solid content of approximately 4.5% by weight (biomass content of approximately 26%).

### Comparative Preparation Example 2

About 50.39 parts by weight of bio-based poly(1,2-propylene succinate), about 20.74 parts by weight of polyethylene glycol and a suitable amount of tetrabutyl titanate were added to a proper amount of acetone, the compositions were stirred at 200 rpm and heated at 40° C. to completely dissolve in acetone. Then, about 20.56 parts by weight of 1,6-hexamethylene diisocyanate was added dropwise, and stirred at 200 rpm, and at a temperature of 50˜60° C. for 30 minutes. Subsequently, about 7.87 parts by weight of 2,2-dimethylol propionic acid was added to obtain a mixed solution. After that, deionized water which volume being 3 times the volume of the aforementioned mixed solution, was added in within 10 minutes at a rotation speed of 500 rpm and a temperature 50˜60° C. Then, at a rotation speed of 500 rpm and a temperature 50˜60° C., within 5 minutes about 0.47 parts by weight of ethylene diamine was added dropwise. Then keep stirring under the same conditions for 1 hour. Next, after removing the acetone with distillation method at a temperature of 50° C., the remaining solution was diluted with water to obtain an aqueous polyurethane dispersion with a solid content of approximately 4.5% by weight (biomass content of approximately 37%).

### Experimental Example 1

A pristine textile (C/F) was impregnated in the aqueous polyurethane dispersion with a solid content of 4.5 weight percent prepared in Preparation Example 1, followed by squeezing out extra solution with a padding mangle (RAPID LABORTEX CO., LTD.) to coat aqueous polyurethane dispersion on the pristine textile (C/T) with impregnation method where the pristine textile (C/T) was a textile made of a mixture of cotton and polyester fiber. Then, dried at a temperature of 140-180° C. for 90-120 seconds to obtain a textile coated with an aqueous polyurethane dispersion. The moisture absorption of the prepared textile was tested in accordance with the AATCC 79 standard, and the results are shown in Table 1.

### Experimental Example 2

The textile of the Experimental Example 2 was prepared by using the same impregnation method as described in Experimental Example 1 with the aqueous polyurethane dispersion prepared by Preparation Example 2 with a solid content of 4.5% by weight. The moisture absorption of the prepared textile was tested in accordance with the AATCC 79 standard. The test results showed that wicking height of the prepared textile was 11.8 cm/15 minutes, and the water absorption time was 2.8 seconds.

### Experimental Example 3

The textile of the Experimental Example 3 was prepared by using the same impregnation method as described in Experimental Example 1 with the aqueous polyurethane dispersion prepared by Preparation Example 1 with a solid content of 4.5% by weight. The moisture absorption of the prepared textile was tested in accordance with the AATCC 79 standard. The test results showed that the wicking height of the prepared textile was 11.6 cm/15 minutes: and the water absorption time is 2.7 seconds.

### Experimental Example 4

The textile of the Experimental Example 4 was prepared by using the same impregnation method as described in Experimental Example 1 with the aqueous polyurethane dispersion prepared in Preparation Example 4 with a solid content of 4.5% by weight. The moisture absorption of the prepared textile was tested in accordance with the AATCC 79 standard. The result was shown in Table 2.

### Experimental Example 5

The aqueous polyurethane dispersion with a solid content of 4.5 weight percent prepared in Preparation Example 4 was injected into a spray-coating machine (APEX DTG, YI SHENG COLOR CO., LTD.), and was spray-coated on the pristine textile (CM. Then, dried at a temperature of 140-180° C. for 90-120 seconds to obtain a textile coated with an aqueous polyurethane dispersion. The moisture absorption of the prepared textile was tested in accordance with the AATCC 79 standard, and the result was shown in Table 2.

### Comparative Example 1

The aqueous polyurethane dispersion prepared in Comparative Preparation Example 1 was prepared with the same spray-coating method as that of Example 5 to prepare a textile, and then the moisture absorption test was performed in accordance with the AATCC 79 standard. The test results showed that the wicking height of the prepared textile was 9.4 cm/15 minutes, and the moisture absorption time was 1.6 seconds.

### Comparative Example 2

The aqueous polyurethane dispersion prepared in Comparative Preparation Example 2 was prepared with the same spray-coating method as that of Example 5 to prepare a textile, and then the moisture absorption test was performed in accordance with the AATCC 79 standard. The test results showed that the wicking height of the prepared textile was 13.1 cm/I5 minutes, and the moisture absorption time was 6.7 seconds.

TABLE 1

| | | pristine textile | Experimental example 1 |
|---|---|---|---|
| Test result | | (C/T) | (impregnation method) |
| wicking | 5 min | 5.8 | 8.4 |
| height (cm) | 10 min | 7.9 | 10.5 |
| | 15 min | 9.4 | 12.2 |
| | 20 min | 10.4 | 13.4 |
| | 25 min | 11.3 | 14.5 |
| | 30 min | 12.0 | 15.2 |

| | | |
|---|---|---|
| water absorption time (s) | 8.5 | 2.8 |

TABLE 2

| | | | Experimental | |
|---|---|---|---|---|
| | | pristine | Example 4 | Experimental |
| | | textile | (impregnation | Example 5 |
| Test result | | (C/T) | method) | (spray-coating) |
| squeezing out extra solution/ | | — | 61 | 31 |
| pick-up percentage (%) | | | | |
| wicking | 5 min | 5.8 | 7.3 | 7.6 |
| height(cm) | 10 min | 7.9 | 9.4 | 9.8 |
| | 15 min | 9.4 | 11.2 | 11.6 |
| | 20 min | 10.4 | 12.3 | 12.7 |
| | 25 min | 11.3 | 13.2 | 13.6 |
| | 30 min | 12.0 | 14.0 | 14.3 |

| | | | |
|---|---|---|---|
| water absorption time (s) | 8.5 | 2.7 | 2.0 |

From the test results of Experimental Examples 1 to 5 and Comparative Experimental Examples 1 to 2, it can be seen that the textile prepared by Experimental Examples 1 to 5, which aqueous polyurethane dispersion includes a bio-based polyurethane with specific compositions, with a weight ratio of the bio-based polyester polyol to hydrophilic polyol is 2.7:1 to 5.3:1, have excellent moisture absorption and moisture wicking properties, and is applicable to textile fiber products. In contrast, the textile prepared by Comparative Examples 1 and 2 which aqueous polyurethane dispersion with a weight ratio of the bio-based polyester polyol to the hydrophilic polyol that is out of the aforementioned range, have poor moisture absorption or moisture wicking property. It can be seen that when the weight ratio of the bio-based polyester polyol to the hydrophilic polyol in the aqueous polyurethane dispersion is less than 2.7:1 (for example 2.4:1) or greater than 5.3:1 (for example 5.6:1), the textile prepared from the aqueous polyurethane dispersion have poor moisture absorption and moisture wicking properties.

As can be seen from Table 1, compared with the textile (pristine textile (C/T)) without the aqueous polyurethane dispersion coating, the textile prepared from the aqueous polyurethane dispersion (Experimental Example 1) with 26% biomass content, has better moisture absorption and moisture wicking properties. It can be seen that, when the aqueous polyurethane dispersion includes bio-based polyurethane, the textile prepared from the aqueous polyurethane dispersion can have better moisture absorption and moisture wicking properties.

As can be seen from Table 2, compared to the textile (pristine textile (C/T)) without the aqueous polyurethane dispersion coating, the textile with the coating of the aqueous polyurethane dispersion with 39% biomass content prepared by impregnation method or spray-coating method (Experimental Examples 4 to 5) have better moisture absorption and moisture wicking properties. In addition, the textile prepared by the spray-coating method have lower squeezing out extra solution/pick-up percentage than the textile prepared by the impregnation method with higher squeezing out extra solution/pick-up percentage. It can be seen that when the aqueous polyurethane dispersion includes bio-based polyurethane, spray-coating method is suitable for preparing functional textile with aqueous polyurethane dispersion, which reduced the usage of the aqueous polyurethane dispersion, and lowering the energy, water and material consumption.

In summary, an aqueous polyurethane dispersion of the present disclosure includes bio-based polyurethane with specific compositions, and when a weight ratio of the bio-based polyester polyol to the hydrophilic polyol is 2.7:1 to 5.3:1, a textile prepared from the aqueous polyurethane dispersion have good moisture absorption and moisture wicking, which is suitable for textile fiber products, thereby reducing the energy and material consumption required to manufacture textile fiber products.

The invention is disclosed in, but not limited to, the above embodiments. It is possible for anyone with ordinary skills in the related art to make some alterations and modifications without departing from the spirit and scope of the invention. Therefore, the protection scope of the invention shall depend on the appended claims.

What is claimed is:

1. An aqueous polyurethane dispersion, comprising:
water; and
a bio-based polyurethane; wherein the bio-based polyurethane comprises: bio-based polyester polyol, hydrophilic polyol, isocyanate and hydrophilic compound, wherein the weight ratio of the bio-based polyester polyol to the hydrophilic polyol is 2.7:1 to 5.3:1.

2. The aqueous polyurethane dispersion as claimed in claim 1, wherein the bio-based polyester polyol comprises poly(1,2-propylene succinate), polypropylene glycol, polycaprolactone glycol, or a combination thereof.

3. The aqueous polyurethane dispersion as claimed in claim 1, wherein the hydrophilic polyol comprises polyethylene glycol, polypropylene glycol, polyethylene glycol-polypropylene glycol copolymer, or a combination thereof.

4. The aqueous polyurethane dispersion as claimed in claim 1, wherein the isocyanate comprises bio-based isocyanate, non bio-based isocyanate, or a combination thereof.

5. The aqueous polyurethane dispersion as claimed in claim 4, wherein the bio-based isocyanate comprises bio-based hexamethylene diisocyanate, pentamethylene diisocyanate, L-lysine diisocyanate or a combination thereof; the non bio-based isocyanate comprises isophorone diisocyanate, toluene diisocyanate, dicyclohexylmethane diisocyanate, or a combination thereof.

6. The aqueous polyurethane dispersion as claimed in claim 1, wherein the hydrophilic compound comprises at least two hydroxyl groups and at least one carboxyl group.

7. The aqueous polyurethane dispersion as claimed in claim 1, wherein the hydrophilic compound comprises glyceric acid, 2,2-dimethylolpropionic acid, 2,2-dimethylolbutyric acid, or a combination thereof.

8. The aqueous polyurethane dispersion as claimed in claim 1, further comprising a chain extender, wherein the chain extender comprising an amine group.

9. The aqueous polyurethane dispersion as claimed in claim 8, wherein the chain extender comprises ethylenediamine, triethylenetetramine, diethylenetriamine, or a combination thereof.

10. The aqueous polyurethane dispersion as claimed in claim 8, wherein the weight ratio of the chain extender to the hydrophilic polyol is 0.02:1 to 0.04:1.

11. The aqueous polyurethane dispersion as claimed in claim 1, wherein the weight ratio of the isocyanate to the hydrophilic polyol is 0.99:1 to 2.18:1.

12. The aqueous polyurethane dispersion as claimed in claim 1, wherein the weight ratio of the hydrophilic compound to the hydrophilic polyol is 0.37:1 to 0.53:1.

13. A textile, prepared using the aqueous polyurethane dispersion as claimed in claim 1.

14. The textile as claimed in claim 13, wherein a wicking height of the textile is greater than 10 cm/15 minutes, and a water absorption time is less than 3 seconds.
